(19) United States
(12) Patent Application Publication
(10) Pub. No.: US 2017/0181402 A1
(43) Pub. Date: Jun. 29, 2017

(54) SINGLE-USE PET SHAMPOO SYSTEM, KIT, AND METHOD OF USE

(71) Applicant: Richard David Ticktin, Fort Lauderdale, FL (US)

(72) Inventor: Richard David Ticktin, Fort Lauderdale, FL (US)

(21) Appl. No.: 14/980,716

(22) Filed: Dec. 28, 2015

(51) Int. Cl. A01K 13/00; B65D 43/02; B65D 25/56

(52) U.S. Cl. CPC A01K 13/001; B65D 25/56; B65D 43/02

(57) ABSTRACT

A single-use shampoo system, kit, and method for delivering concentrated dilutable hair care products is disclosed. The single-use shampoo system includes a first single-use packet sized and shaped to fit within a standard-sized A4 envelope. A quantity of shampoo concentrate is stored within the first single-use packet.

### FIELD OF THE INVENTION

The present invention relates generally to grooming, and, more particularly, relates to a single-use shampoo system, kit, and method for delivering concentrated dilutable hair care products.

### BACKGROUND OF THE INVENTION

It is well known that frequently bathing, i.e., grooming, an essential part of maintaining a healthy lifestyle. This is especially important for maintaining a healthy pet. Many pet owners utilize the services of a mobile pet groomer. Other pet owners choose to take their pet to a grooming facility or to wash their pet at home. Unfortunately, shampoo, e.g., concentrated shampoo, often comes in large, heavy containers with sizes ranging up to 2.5, 5, or even 10 gallons. For retail stores, the large, heavy containers occupy a large amount of shelving space and are difficult to handle and transport by store employees and customers, e.g., caretakers. This is a serious problem for mobile groomers working in confined spaces. Moreover, the large containers are difficult to maneuver and inconvenient for the caretaker. This is especially true when the shampoo is poured from the large container into the caretaker's hand or directly onto the pet. Furthermore, when concentrated, the shampoo must be measured and diluted with a certain volume of water. Calculating the appropriate amount of concentrated shampoo and the appropriate volume of water is often an inconvenient and difficult task. Miscalculating the correct concentration ratio of shampoo to water can often lead to irritation and/or pain experienced by the pet. This task can be especially difficult when the pet is present and resisting the bath. The difficulty of handling a large, heavy shampoo container increases the stress and inconvenience of washing the pet.

The large shampoo containers are especially inconvenient for groomers, especially mobile groomers, who carry several different types of shampoo as individual pets often require individualized shampoo. Known shampoos contain additives, such as medications, conditioners and/or fragrances. Many pets, however, are allergic to the additives. Unfortunately, known shampoos do not allow the caretaker to customize the shampoo by the addition of select additives.

As an added problem, several known shampoos are not manufactured at ideal concentrations. If the concentration of the shampoo is lower than necessary, more shampoo is required to achieve the same level of cleanliness as that which would occur with a smaller quantity of shampoo that is higher in concentration. As such, additional shampoo containers are purchased from retail stores and transported by the caretaker, which is especially inconvenient for groomers, e.g., mobile groomers.

Therefore, a need exists to overcome the problems with the prior art as discussed above.

### SUMMARY OF THE INVENTION

The invention provides a single-use shampoo system, kit, and method of use that overcomes the hereinafore-mentioned disadvantages of the heretofore-known devices and methods of this general type and that can be easily transported and diluted with water prior to bathing a pet.

With the foregoing and other objects in view, there is provided, in accordance with the invention, a single-use shampoo system for delivering concentrated dilutable hair care products. The single-use shampoo system includes a first single-use packet sized and shaped to fit within a standard-sized A4 envelope, and a quantity of shampoo concentrate stored within the first single-use packet.

In accordance with a further feature of the present invention, the single-use shampoo system includes a second single-use packet sized and shaped to fit within a standard-sized A4 envelope, and a quantity of shampoo additive stored within the second single-use packet.

In accordance with an additional feature of the present invention, the quantity of shampoo additive is a medication, a fragrance, and/or a conditioner.

In accordance with yet another feature of the present invention, the single-use shampoo system includes a dilution container sized and shaped to receive the quantity of shampoo concentrate. The dilution container includes a visual indicia corresponding to a volume fill amount.

In accordance with another feature of the present invention, the dilution container further includes a removably couplable bottom portion sized and shaped to receive the first single-use packet.

In accordance with another feature of the present invention, the quantity of shampoo concentrate includes a dilution strength of approximately 10 parts of water to 1 part shampoo.

In accordance with a further feature of the present invention, the single-use shampoo system includes a display holder having a base and a support wall, the base defining an aperture sized and shaped to receive the first single-use packet.

In accordance with yet another feature of the present invention, the quantity of shampoo concentrate is less than five fluid ounces.

In accordance with another feature, an embodiment of the present invention includes a kit for providing custom dilutable hair care products for one time use. The kit includes a first packet defining a volume of less than five fluid ounces, a quantity of shampoo concentrate stored within the first packet, a second packet defining a volume of less than five fluid ounces, a quantity of shampoo additive stored within the second packet, a dilution container sized and shaped to receive the quantity of shampoo and the quantity of shampoo additive, and a compact storage case operable to transport the kit.

In accordance with a further feature of the present invention, the kit includes a dilution container cover removably coupled to the dilution container.

In accordance with a further feature of the present invention, the kit includes an elongated mixing member.

In accordance with yet another feature, the quantity of shampoo additive within the kit is at conditioner, a medication, and/or a fragrance.

In accordance with a further feature of the present invention, the dilution container within the kit includes a removably couplable bottom sized and shaped to receive at least one of the first packet and the second packet.

In accordance with a further feature of the present invention, the dilution container within the kit includes a protruding member shaped to pierce at least a portion of the first packet.

In accordance with the present invention, a method for using a single-use shampoo system for delivering concentrated dilutable hair care products includes providing a first single-use packet sized and shaped to fit within a standard-sized A4 envelope, a quantity of shampoo concentrate stored within the first single-use packet, and a dilution container having a removably couplable bottom portion sized and shaped to receive the first single-use packet. The method further includes transferring the quantity of shampoo concentrate from the first single-use packet to the dilution container, diluting the quantity of shampoo concentrate to a select dilution strength with a volume of water, and bathing a pet with the quantity of shampoo concentrate and the volume of water.

In accordance with yet another feature, the method includes providing a second single-use packet sized and shaped to fit within a standard-sized A4 envelope, and a quantity of shampoo additive stored within the second single-use packet.

In accordance with a further feature, the method includes adding the quantity of shampoo additive to the quantity of shampoo concentrate and the volume of water.

In accordance with another feature, the method includes inserting the first single-use packet within the bottom portion of the dilution container.

In accordance with a further feature of the present invention, the method includes providing the first single-use packet and the dilution container as part of a kit, the dilution container having a visual indicia corresponding to the volume of water.

In accordance with a further feature of the present invention, the method includes disposing of the first single-use packet following use.

Although the invention is illustrated and described herein as embodied in a single-use shampoo system, kit, and method of use, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward. The figures of the drawings are not drawn to scale.

Before the present invention is disclosed and described, it is to be understood that the terminology used herein is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts, at once or over a period of time.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 is a perspective front view of an interior of an exemplary mobile vehicle implementing a single-use shampoo system having a packet containing a quantity of shampoo concentrate in accordance with an embodiment of the present invention;

FIG. 2 is an elevational front view of the packet of FIG. 1;

FIG. 3 is an elevational front view of the packet of FIG. 1 having a transparent outer portion showing the quantity of shampoo concentrate within an inner portion of the first packet;

FIG. 4 is an elevational front view of a second packet containing a quantity of shampoo additive in accordance with an embodiment of the present invention;

FIG. 5 is an elevational front view of the second packet of FIG. 4 having a transparent outer portion showing the shampoo additive within an inner portion of the second packet;

FIG. 6 is a perspective view of a display holder for displaying one or more packets;

FIG. 7 is a perspective view of a dilution container for receiving the shampoo concentrate and a volume of water in accordance with an embodiment of the present invention;

FIG. 8 is a perspective view of a kit for transporting custom dilutable hair care products for a single-use in accordance with an embodiment of the present invention;

FIG. 9 is a process flow diagram for illustrating a process of using the single-use shampoo in accordance with an embodiment of the present invention; and

FIG. 10 is a perspective view of the dilution container having a removable bottom in accordance with an embodiment of the present invention.

### DETAILED DESCRIPTION

While the specification concludes with claims defining the features of the invention that are regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

The present invention provides a novel and efficient single-use shampoo system, kit, and method for delivering concentrated dilutable hair care products. The present invention is intended to be used mainly with pets, but may be used by humans or other species as well. Generally speaking, the term “pet” is defined herein as a domestic animal normally kept for companionship, such as a cat or a dog. Embodiments of the invention provide a first packet and a second packet containing a shampoo concentrate and a shampoo additive, respectfully. The packets are sized and shaped to fit within a standard-sized A4 envelope. Advantageously, the single-use shampoo system provides caretakers, especially mobile pet groomers, with a shampoo concentrate and a shampoo additive that can be easily and conveniently transported, eliminating the inconvenience of carrying large heavy shampoo containers.

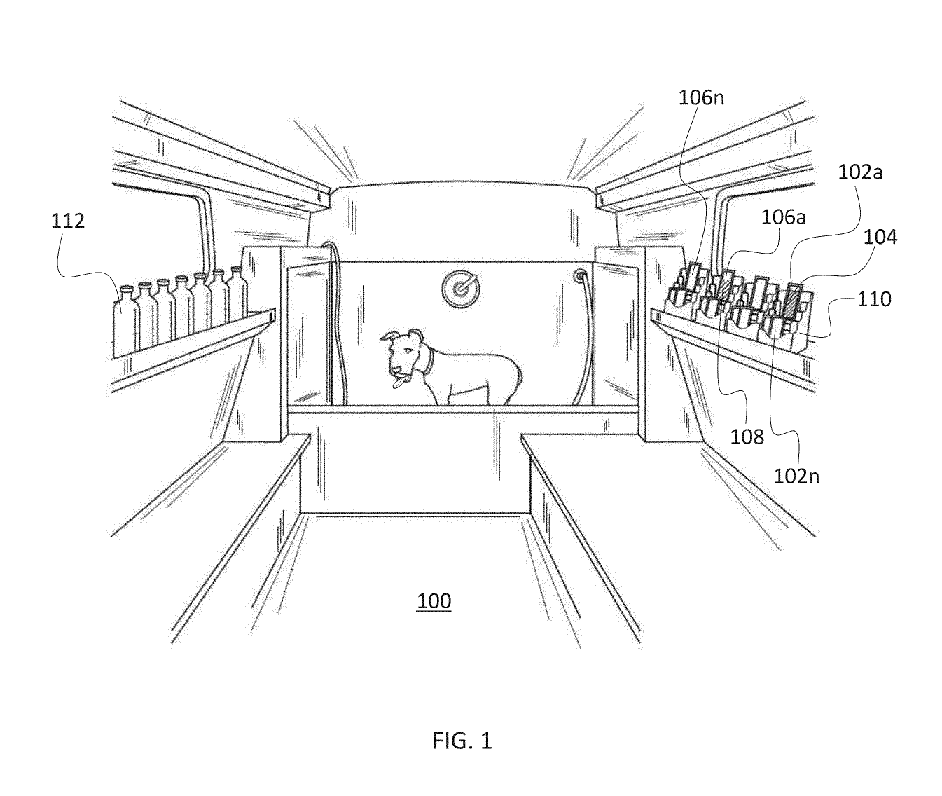

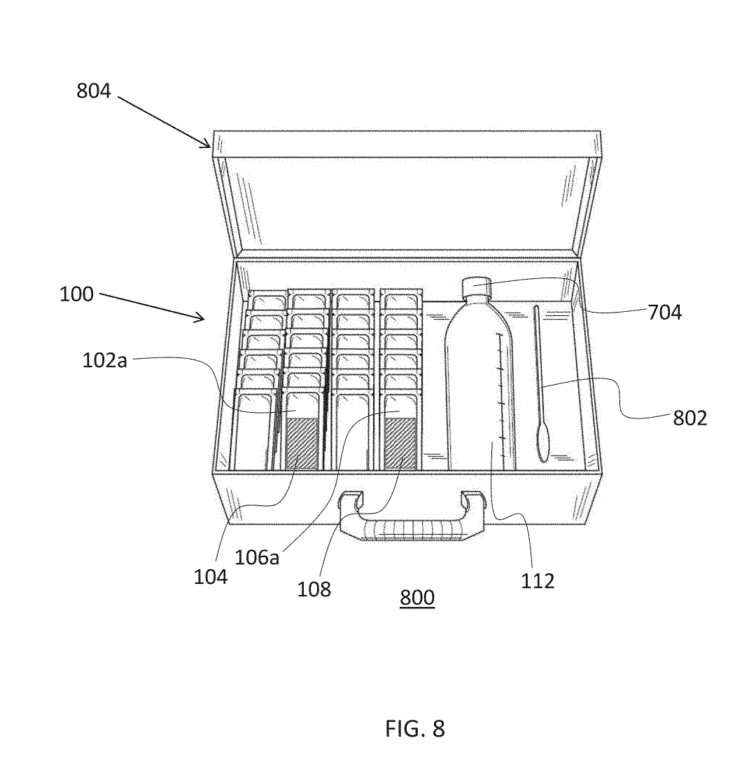

Referring now to FIG. 1, one exemplary implementation of a single-use shampoo system 100, or “kit,” for delivering concentrated dilutable hair care products is depicted within an interior of a mobile grooming vehicle, such as those used for grooming pets. An exemplary kit 800 is also depicted in FIG. 8. FIGS. 1 and 8 show several advantageous features of the present invention, but, as will be described below, the invention can be provided in several shapes, sizes, combinations of features and components, and varying numbers and functions of the components. In one embodiment, the single-use shampoo system 100, as shown in FIG. 1, includes a first packet 102a sized and shaped to fit within a standard-sized A4 envelope, as will be explained further herein. Advantageously, the size and shape of the first packet 102a allows it to be conveniently transported, thereby eliminating the need for caretakers to transport large, heavy containers of concentrated shampoo. As an added advantage, retail stores no longer have to order, stock, and sell the large, heavy shampoo containers that take up an abundance of space on the store shelves and which are difficult to handle and transport. Rather, retail stores can order, stock, and sell the first packet 102a that takes up less shelving space, and is easier to handle and transport by both store employees and customers, e.g., caretakers. In other embodiments, the first packet 102a may be sized and shaped to exceed the measurements of a standard-sized A4 envelope.

In one embodiment, the first packet 102a includes a quantity of shampoo 104, i.e., shampoo concentrate, temporarily stored within the first packet 102a. The terms “shampoo” and “shampoo concentrate” may be used interchangeably with respect to the shampoo system 100. The single-use shampoo system 100 may include a plurality of packets 102a-n, each having different types of shampoo 104 contained within the packets 102a-n. The indicator “a-n” is intended to represent any number of items, with “a” indicating 1 and “n” indicating any number greater than 1. For example, the single-use shampoo system 100 may include 10 packets, 20 packets, 30 packets, etc. In a preferred embodiment, the quantity of shampoo 104 is less than five fluid ounces. In other embodiments, the quantity of shampoo 104 may be five fluid ounces or more. In a preferred embodiment, the quantity of shampoo 104 is an amount that is adequate to perform a single bath, e.g., a pet bath. In other embodiments, the quantity of shampoo 104 may be an amount that is adequate for use during more than one bath. As such, the first packet 102a can be easily discarded following a single, i.e., one time, use.

In a preferred embodiment, the shampoo 104 is concentrated beyond a concentration suitable for normal use. In other words, in order to be safe and/or effective, the concentrated shampoo 104 requires the addition of a solvent such as, for example, water. Said yet another way, the shampoo 104 is designed to be diluted with a volume of water prior to bathing a pet. The “shampoo concentrate” is defined herein as a product that has been concentrated, such as through a reduction in volume by the removal of a liquid, or otherwise concentrated such that the addition of a solvent is required prior to normal use as a shampoo suitable for normal use on a pet. Non-concentrated shampoo, in contrast, is that which can be and is intended to be applied directly to wet hair straight from the container. In one embodiment, the shampoo 104, i.e., shampoo concentrate, may be in the form of a powder. In another embodiment, the shampoo 104 may be in the form of a liquid containing greater than 20% solids.

In one embodiment, the single-use shampoo system 100 includes a second packet 106a sized and shaped to fit within a standard-sized A4 envelope. In one embodiment, the second packet 106a includes a quantity of shampoo additive 108 stored within the second packet 106a. The single-use shampoo system 100 may include a plurality of second packets 106a-n, each having different types of shampoo additives 108 contained within the second packets 106a-n. The term “additive” is defined as a shampoo product added in a relatively small amount to a shampoo to improve, strengthen, or otherwise alter the shampoo. The shampoo additive 108 may be a medication, a fragrance, a conditioner, or other additive, as will be explained further herein. In a preferred embodiment, the quantity of shampoo additive 108 is less than five fluid ounces. In other embodiments, the quantity may be greater than five fluid ounces. In one embodiment, the quantity of shampoo additive 108 is an amount that is adequate for use during a single bath, e.g., a pet bath. As such, the second packet 106a can be discarded following a single use. In other embodiments, the quantity of shampoo additive 108 may be an amount that is adequate for use during more than one bath.

In one embodiment, the single-use shampoo system 100 includes a display holder 110 for displaying the packets 102a, 106a, containing the various types of shampoo 104 and the shampoo additives 108. The display holder 110 provides the retail stores and caretakers, with an easy and convenient way of displaying the packets 102a, 106a so that the caretaker can simply choose the packets 102a, 106a having the type of shampoo 104 and/or shampoo additive 108 best suited for individual pets. The term “caretaker” is defined herein as a mobile pet groomer, a pet owner, a pet sitter, or any other person responsible for grooming a pet. In one embodiment, the single-use shampoo system 100 includes a dilution container 112 sized and shaped to receive the shampoo 104 and a volume of water prior to bathing, as will be explained further herein.

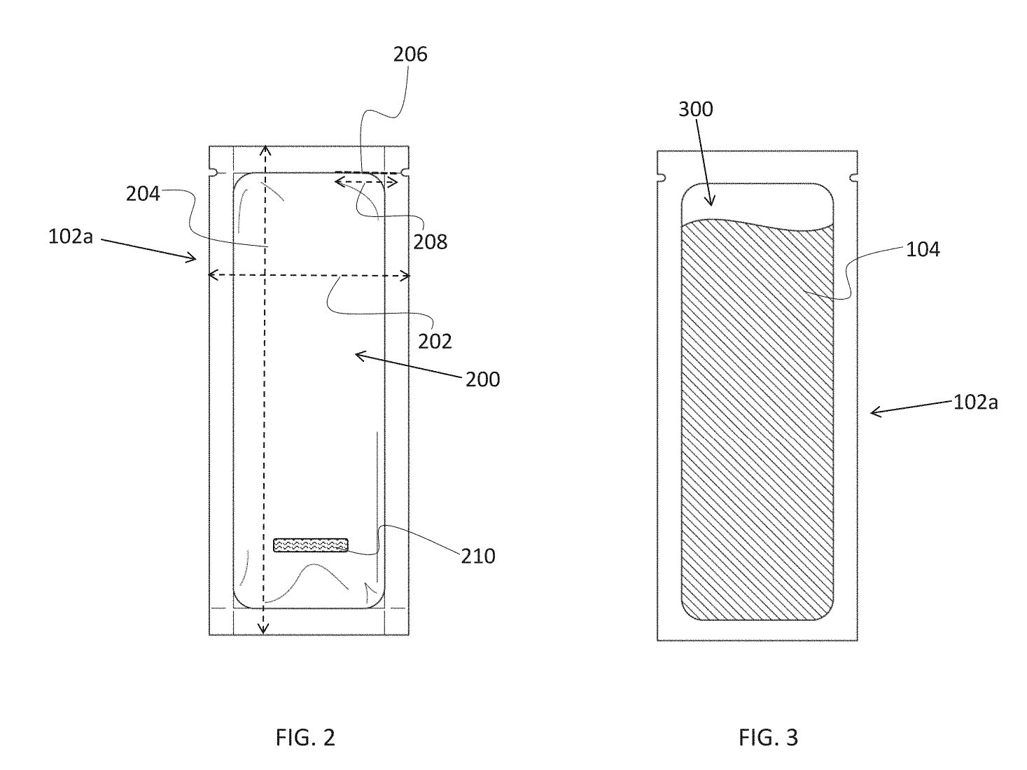

FIG. 2 depicts an elevational front view of one embodiment of the first packet 102a. The material of the first packet 102a may be made of a durable, lightweight material, such as Mylar, plastic, e.g., polyethylene, polyvinyl chloride, polypropylene, or another similar type of material. In one embodiment, the material of the first packet 102a may be recyclable. In another embodiment, the first packet 102a may be made of a material, for example, without limitation, a film comprising polyvinyl alcohol, configured to dissolve in water. Advantageously, the first packet 102a can be placed in water such that the first packet 102a dissolves and releases the contents within the first packet 102a. As such, the material of the first packet 102a may prevent pollution to the environment.

The first packet 102a includes a first outer portion 200. In one embodiment, the first packet 102a, more specifically the first outer portion 200, may be a width 202 that is approximately 1 to 2 inches. In other embodiments, the width 202 may be outside of this range. In one embodiment, the first packet 102a includes a length 204 that is approximately 2 to 4 inches. In other embodiments, the length 204 may be outside of this range. In one embodiment, the first outer portion 200 may be in the shape of a rectangle. In another embodiment, the first outer portion 200 may be in the shape of a circle. In this embodiment, the first outer portion may include a circumference that is approximately 2 to 4 inches in length. In other embodiments, the circumference may be a length that is outside of this range. In other embodiments, the first outer portion 200 may in the shape of a dog bone, a standard shampoo bottle, a bottle, or the like. The first outer portion 200 may be a variety of colors, e.g., red, blue, green, etc. or may be transparent, allowing the caretaker to see whether any shampoo 104 (as shown in FIG. 3) remains within the first packet 102.

Advantageously, the first packet 102a can be mailed, from a manufacturer, distributor, retail store, or the like, to the caretaker, in an efficient manner due to the first packet 102a being sized and shaped to fit within a standard-sized A4 envelope, such as those often utilized for storing photographs, greetings cards, small booklets, promotional materials, and the like. A standard-sized A4 envelope is generally 4.75 inches in width and 6.5 inches in length. As an added advantage, caretakers can transport various types of shampoo 104 (as shown in FIG. 3) in small, convenient packages. The inconvenience of pouring the shampoo 104 (as shown in FIG. 3) from a large, heavy container into a secondary container or directly onto the pet, is also eliminated.

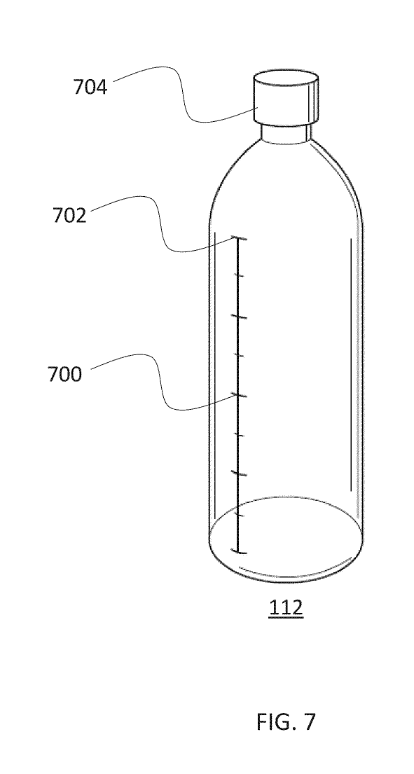

In one embodiment, the first outer portion 200 includes a first perforated edge 206, e.g., a puncture region. The first perforated edge 206 may be a width 208 that is less than half of the overall width 202 of the first packet 102a. The first perforated edge 206 provides an easy and convenient starter point for the caretaker to open the first packet 102a for easy access to the shampoo 104 (as shown in FIG. 3). In another embodiment, the first outer portion 200 may include a seal, e.g., a twist off cap, which can be easily removed for convenient access to the shampoo 104. In one embodiment, the seal cannot be reattached to the remainder of the first outer portion 200 once removed. As such, the quantity of shampoo 104 is intended to be used in a single bath. In other embodiments, the seal may be reattached to the remainder of the first outer portion 200. In one embodiment, the seal may be a cap (FIG. 7) having an open mode and a closed mode. In the open mode, the cap may be configured to release the shampoo 104 (FIG. 3) in a spray pattern to effectively penetrate the pet's coat, with the addition of water. In the closed mode, the cap may be configured to retain the contents within the first shampoo packet 102a for later use.

In one embodiment, the first outer portion 200 includes a visual indicia 210. In one embodiment, the visual indicia 210 includes instructions for diluting the shampoo 104 (as shown in FIG. 3) to a concentration. The concentration may depend on the ingredients and quantity of the shampoo 104. Advantageously, the instructions eliminate the need for performing manual calculations to arrive at the appropriate concentration of the shampoo 104. In a preferred embodiment, the concentration exceeds a concentration suitable for normal use. Said another way, the shampoo 104 is designed to be mixed with a volume of water, prior to bathing. The volume of water necessary to dilute the shampoo 104 varies, according to the type of shampoo 104 contained within the first packet 102a. In one embodiment, the concentration ratio, i.e., dilution strength, is one part shampoo 104 to ten parts of water. In other embodiments, the concentration ratio may be outside of this ratio. In other embodiments, the visual indicia 210 may include a list of the ingredients contained within the shampoo 104.

FIG. 3 depicts the first packet 102a having a first inner portion 300. In one embodiment, as previously mentioned herein, the first outer portion 200 (as shown in FIG. 2) may be transparent, providing the caretaker with the ability to see the shampoo 104 contained within the first inner portion 300. The shampoo 104 may be any one of a number shampoos 104, e.g., moisturizing, anti-bacterial, deodorizing, and the like. In one embodiment, the shampoo 104 may contain all natural ingredients such as purified water, coconut oil based surfactants, tea tree oil and/or neem oil. In one embodiment, the shampoo 104 may have conditioning properties through ingredients such as aloe vera, an oatmeal formula, vitamins and minerals, vanilla, and other similar soothing ingredients. In yet another embodiment, the shampoo may contain a non-tearing formula. In other embodiments, the shampoo 104 may contain at a least one of a medication and a fragrance.

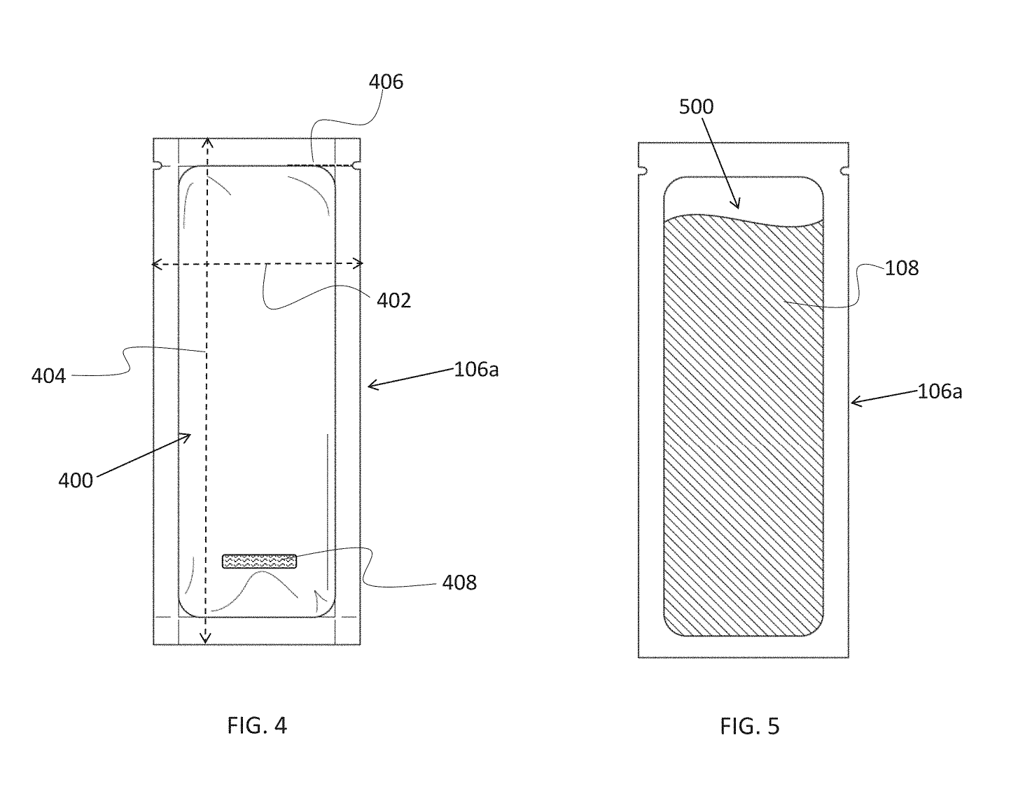

FIG. 4 depicts the second packet 106a having a second outer portion 400. The material of the second packet 106a may be made of a durable, lightweight material, such as Mylar, polyethylene, polyvinyl chloride, polypropylene, or another similar type of material. In one embodiment, the material of the second packet 106 may be recyclable, thereby preventing pollution to the environment. In one embodiment, the second packet 106a may be made of a material, e.g., a film, configured to dissolve in water. Advantageously, the second packet 106a can be placed in water such that the second packet 106a dissolves and releases the contents within the second packet 106a.

In one embodiment, the second outer portion 400 may be in the shape of a rectangle. In one embodiment, the second outer portion 400 includes a width 402 and a length 404 that are the same dimensions as discussed with respect to the outer portion 300 of the first packet 102 (FIG. 2). In another embodiment, the width 402 may be approximately 0.5 to 1 inch and the length 404 may be approximately 1.5 to 3 inches. In other embodiments, the width 402 and the length 404 may be outside of these ranges. In another embodiment, the second outer portion 400 may be in the shape of a circle. More specifically, in this embodiment, the second outer portion 400 may include a circumference that is approximately 2 to 4 inches in length. In other embodiments, the circumference may be a length that is outside of this range. In other embodiments, the second outer portion 400 may be in the shape of a dog bone, a standard shampoo bottle, another bottle shape, or the like. The second outer portion 400 may be a variety of colors, e.g., red, blue, green, etc. or may be transparent, allowing the caretaker to see whether any shampoo additive 108 (as shown in FIG. 5) remains within the second packet 106a.

In one embodiment, the first packet 102a (as shown in FIG. 2) and the second packet 106a may be offered as a kit, in which the shape, and or color of the outer portions 200, 400 provide a uniform appearance that may each represent different types of shampoo 104. Individual kits may be compatible with the individual needs of the pet. For example, a green outer portion 200, 400 may represent a medicated shampoo 104 and/or shampoo additive 108 for pets prone to fleas and a blue outer portion 200, 400 may represent a non-medicated shampoo 104 and/or shampoo additive 108 for pets with sensitive skin.

In one embodiment, the second outer portion 400 includes a second perforated edge 406, e.g., a puncture region, similar to the first perforated edge 206 of FIG. 2. In another embodiment, the second outer portion 400 may include a seal, e.g., a twist off cap. In one embodiment, the seal cannot be reattached to the remainder of the second outer portion 400 once removed. As such, the quantity of shampoo additive 108 is intended to be used in a single bath. In other embodiments, the seal may be reattached to the remainder of the second outer portion 400. In one embodiment, the seal may be a cap (FIG. 7) having an open mode and a closed mode. In the open mode, the cap may be configured to release the shampoo 104, and the shampoo additive 108 (FIG. 5) in a spray pattern to effectively penetrate the pet's coat, with the addition of water. In the closed mode, the cap may be configured to retain the contents within the second shampoo packet 106a.

In one embodiment, the second outer portion 400 includes a visual indicia 408. In one embodiment, the visual indicia 408 indicates the type of shampoo additive 108 (FIG. 5) stored within the second packet 106a. In other embodiments, the visual indicia 408 contains a list of ingredients stored within the second packet 106a.

FIG. 5 depicts the second packet 106a having an inner portion 500. In one embodiment, as previously mentioned herein, the second outer portion 400 (FIG. 4) is transparent, providing the caretaker with the ability to see the shampoo additive 108 contained within the inner portion 500. The shampoo additive 108 may be a conditioner, a medication, a fragrance, or any combination thereof. More specifically, in one example, a conditioner, e.g., a detangling conditioner, can be added to the shampoo 104 for pets having a coat that is prone to matting and tangling. In another example, a medication, e.g., flea medication, can be added to the shampoo 104 to eliminate or prevent fleas. In yet another example, a fragrance, e.g., a deodorizing fragrance, can be added to the shampoo 104 for a pleasant smelling pet. Advantageously, the shampoo additive 108 provides the caretaker with the ability to create custom hair care products that can be transported in the small and convenient packets 102a, 106a and diluted with water prior to use. Following use, similar to the first packet 102a, the second packet 106a may be discarded.

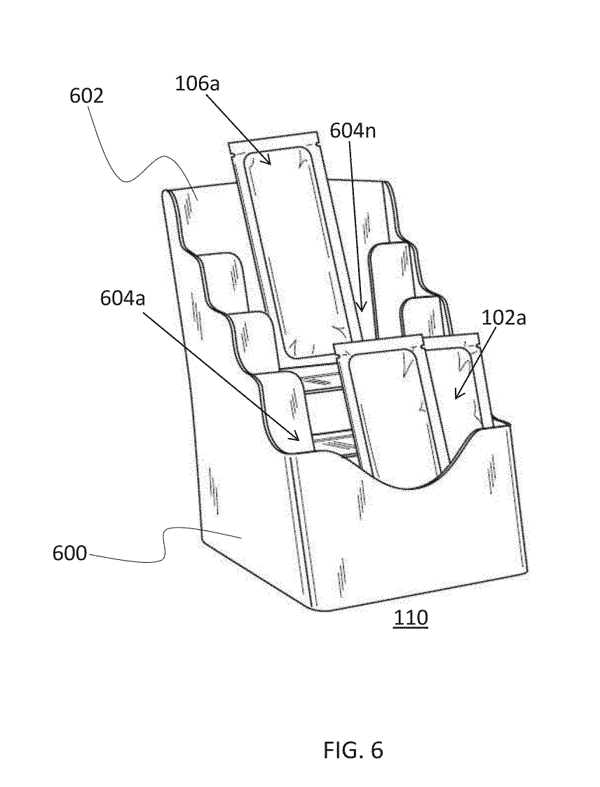

FIG. 6 shows a perspective view of the display holder 110. Advantageously, the display holder 110 provides the caretaker with an easy and convenient manner of displaying the packets 102a, 106a. As such, the caretaker can easily access the desired type of shampoo 104 and shampoo additive 108 (as shown in FIG. 1) suitable for the individual pet. Easy access to the packets 102a, 106a may be especially advantageous for the caretaker when the pet is anxious and resisting the bath. In one embodiment, the display holder includes a base 600 and a support wall 602. In one embodiment, the material of the base 600 and the support wall 602 is acrylic. In other embodiments, the material of the base 600 and the support wall may be wood, plastic, e.g., ABS plastic, or another polymer material that is lightweight and durable.

In one embodiment, the base 600 defines an aperture 604a sized and shaped to receive the first packet 102a and/or the second packet 106a. In a preferred embodiment, the display holder 110 includes a plurality of apertures 604a-n for displaying the packets 102a-n, 106a-n. The indicator “a-n” is intended to represent any number of items, with “a” indicating 1 and “n” indicating any number greater than 1. In one embodiment, the aperture 604a may be in the shape of a rectangle. In other embodiments, the aperture 604a may be in the shape of a square or another shape configured to receive the packets 102a-n, 106a-n. In one embodiment, the aperture 604a may be sized to receive the packets 102a-n, 106a-n having a width of 1 to 2 inches and a length of 2 to 4 inches. In other embodiments, the aperture 604a may be sized to receive the packets 102a-n, 106a-n having dimensions outside of this range. In other embodiments, the display holder 110 may include a clip, a clasp, or another fastener for holding and displaying the packets 102a-n, 106a-n.

FIG. 7 shows the dilution container 112 sized and shaped to receive the quantity of shampoo 104 (as shown in FIG. 3) and the volume of water necessary to dilute the shampoo 104 to the appropriate dilution strength. In one embodiment, the shampoo additive 108 (as shown in FIG. 5) may also be added to the dilution container 112. In one embodiment, the dilution container 112 is a bottle having a lid. In this embodiment, the dilution container 112 can be shaken to sufficiently mix the contents within the dilution container 112. In other embodiments, the dilution container 112 may be a measuring cup or other type of container. In this embodiment, the dilution container 112 may have a separate cover or a separate mixing member to sufficiently mix the contents within the dilution container 112. In one embodiment the dilution container 112 may be covered with a dilution container cover 704 for sealing the contents of the dilution container 112. In one embodiment, the dilution container cover 704 is a plastic lid. In other embodiments, the dilution container cover 704 may be a rubber cap or another type of cover. In one embodiment, the dilution container 112 is sized to hold approximately 12 to 18 ounces of fluid. In other embodiments, the dilution container 112 may be sized to hold a volume of fluid outside of this range.

FIG. 7 shows the dilution container 112 having a visual indicia 700 corresponding to a volume of fluid within the dilution container 112. For example, the visual indicia 700 may be in the form of horizontal lines, wherein the horizontal lines represent the volume of fluid ounces within the dilution container 112. The term “fluid” is defined herein as any liquid that is capable of flowing. The fluid may be the shampoo 104 (as shown in FIG. 1), the shampoo additive 108 (as shown in FIG. 1), a volume of water, another fluid normally used when grooming a pet, or any combination thereof. The visual indicia 700 may include a volume fill maximum 702, indicating the maximum amount of fluid that can be added to the container 112. Advantageously, the visual indicia 700 eliminate the need for the caretaker to measure the volume of fluid with a separate measuring apparatus, such as a measuring cup. In one embodiment, the dilution container 112 itself may be made of a transparent or translucent material to permit the caretaker to view the level of fluid in the dilution container 112. In other embodiments, the dilution container 112 may be a variety of colors, e.g., red, blue, green, etc.

With reference to FIG. 8, the single-use shampoo system 100 may be provided in the kit 800. In one embodiment, the kit 800 includes the first packet 102a, the shampoo 104, the second packet 106a, the shampoo additive 108, and the dilution container 112 (FIG. 1). In another embodiment, the kit 800 includes the aforementioned items, and an elongated stirring member 802 used to stir the contents of the dilution container 112. In one embodiment, the elongated stirring member 802 may be a spoon. In other embodiments, the elongated stirring member 802 may be a stirring stick. In other embodiments, the kit 800 may also include a dilution container cover, such as the dilution container cover 704 (FIG. 7) for sealing the contents of the dilution container 112.

The kit 800 is easily transported in a convenient compact storage case 804. The term “compact” is defined herein as closely or firmly packed together. FIG. 8 shows the compact storage case 804 as a plastic case. In other embodiments, the compact storage case 804 may be a case made of another material, e.g., steel, rubber, metal, or another similar durable, yet lightweight material that can easily be transported. In other embodiments, the compact storage case 804 may be a briefcase, a piece of luggage, or another convenient case for traveling. Advantageously, the compact storage case 804 offers caretakers the ability to transport the kit 800 to various locations, e.g., homes, pet owners' homes, pet boarding facilities, veterinarian offices, and the like.

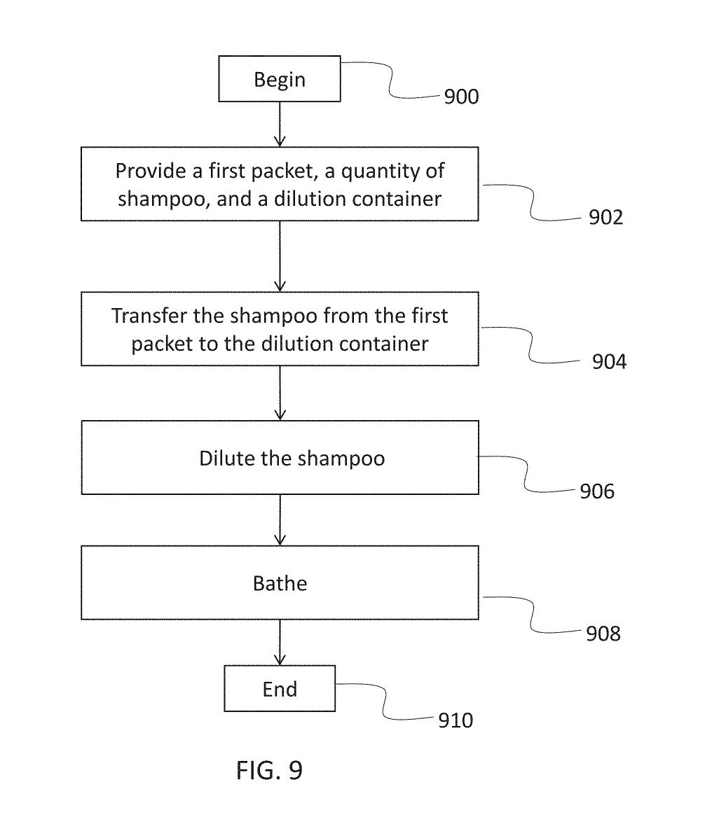

Referring primarily to FIG. 9, in conjunction with FIGS. 1 through 7, there is provided a method of using a single-use shampoo system for delivering concentrated dilutable hair care products, such as the single-use shampoo system 100 from FIG. 1. It is envisioned that the method of using the single-use shampoo system 100 is usable for pet caretakers, especially mobile pet groomers.

The process of FIG. 9 begins at step 900 and moves directly to step 902, where a first packet, e.g., a first single-use packet, sized and shaped to fit within a standard-sized A4 envelope, such as the first packet 102a of FIG. 1 is provided, i.e., brought into physical existence. The first packet 102 includes a quantity of shampoo concentrate, such as the shampoo 104. The ingredients within the shampoo 104 may vary for use on various skin types of pets. Advantageously, the caretaker can select the first packet 102a based on the skin type of the pet. In order to further customize the hair care products, a second packet, i.e., a second single-use packet, sized and shaped to fit within a standard-sized A4 envelope, such as the second packet 106a may also be provided. The second packet 106a contains a quantity of shampoo additive, such as the shampoo additive 108. The shampoo additive 108 may be a conditioner, a medication, a fragrance, or any combination thereof. In the alternative, the shampoo 104 itself may contain a conditioner, a medication, a fragrance, or any combination thereof.

In order for the first packet 102 to be conveniently transported, in a preferred embodiment, the quantity of shampoo 104 is less than five fluid ounces. As such, the quantity of shampoo 104 can be used during a single bath and the first packet 102a can be discarded following use. In other embodiments, the quantity of shampoo 104 may be five fluid ounces or more. In step 902, a dilution container, such as the dilution container 112, is also provided. In one embodiment, the dilution container 112 is a bottle with a lid. In another embodiment, the dilution container 112 may be a measuring cup. In step 904, the shampoo 104 is transferred from the first packet 102a to the dilution container 112. A funnel or other similar apparatus for guiding liquid into an opening may be used to transfer the shampoo 104 into the dilution container 112.

The process proceeds to step 906 where the shampoo 104 is diluted with a volume of water to reach a desired dilution strength. The volume of water necessary to reach the desired dilution strength may vary, depending on the type of shampoo 104. In one embodiment, the concentration ratio may be approximately one part shampoo 104 to ten parts water. In another embodiment, the concentration ratio may be approximately one part shampoo 104 to eight parts water. In other embodiments, the concentration ratio may be outside of these ratios.

The shampoo additive 108 may be added to the dilution container 112, more specifically, to the shampoo 104 and the volume of water, when desired. The contents of the dilution container 112 may be shaken or stirred to thoroughly mix the contents together. In one embodiment, a dilution container cover, such as the dilution container cover 704 may be provided to prevent the contents of the dilution container 112 from leaking during mixing. In another embodiment, a mixing member, such as the elongated stirring member 802, may be provided to stir the contents of the dilution container 112. In one embodiment, the first packet 102a and the dilution container 112 may be provided in a kit, such as the kit 800. The kit 800 may also include the second packet 106a, the dilution container 112, the dilution container cover 704, and the elongated stirring member 802.

The process proceeds to step 908 of bathing a pet with the shampoo 104 and the volume of water. The shampoo additive 108 may also be used to bathe the pet when desired. The pet can be bathed in a number of places, e.g., the mobile pet grooming vehicle, outside, in a home bathroom, in a veterinary clinic, or the like, without the caretaker having to transport large, heavy shampoo bottles. The first packet 102a and the second packet 106a can easily be discarded following the single bath. The process ends at step 910. The steps delineated in FIG. 9 are merely the exemplary of the preferred order of using a single-use shampoo system for delivering concentrated dilutable hair care products and said steps may be carried out in another order, with or without additional steps included therein.

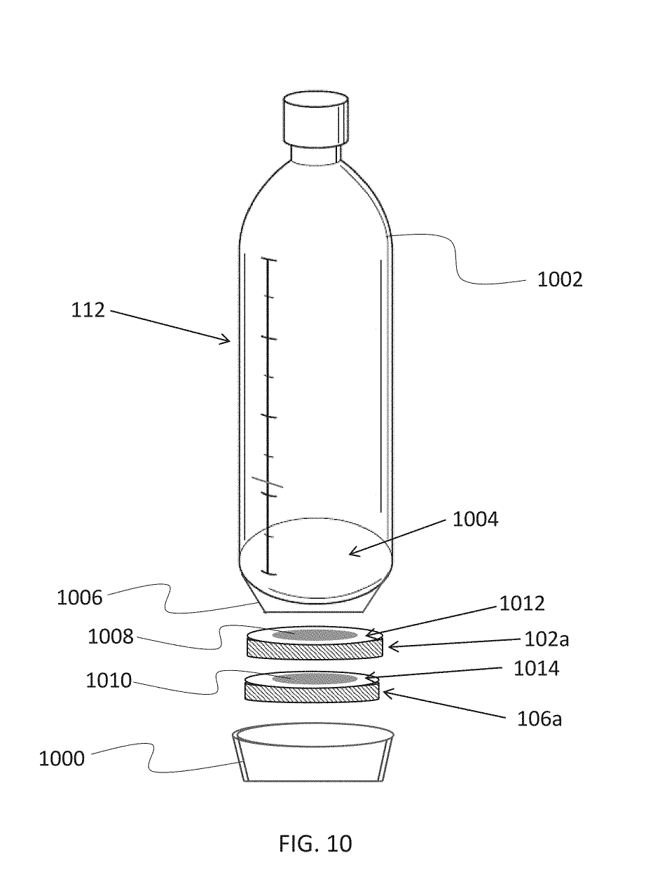

FIG. 10 shows the dilution container 112 of the above described single-use shampoo system 100, or “kit,” of FIGS. 1 and 8, having a bottom portion 1000. In one embodiment, the dilution container 112 includes a body 1002 defining an opening 1004. The opening 1004 is configured to receive the bottom portion 1000, e.g., cap, operable to seal the opening 1004 and keep fluid within the dilution container 112. In one embodiment, the bottom portion 1000 is removably couplable to the body 1002. In one embodiment, the bottom portion 1000 may be removably coupled to the body 1002 through a twist-cap type configuration, wherein the bottom portion 1000 and the body 1002 include male and female grooves. In another embodiment, the bottom portion 1000 may be removably coupled to the body 1002 through a snap in type configuration. In other embodiments, the bottom portion 1000 may be removably coupled to the body 1002 through another type of sealing mechanism.

The bottom portion 1000 is sized and shaped to receive at least one of the first packet 102a and the second packet 106a. In one embodiment, the first packet 102a and the second packet 106a may be formed in a circular shape, as previously described herein. In other embodiments, the first packet 102a and the second packet 106a may be formed in alternate shapes, depending on the shape of the body 1002 and the bottom portion 1000. Similarly, the dimensions of the first packet 102a and the second packet 106a may vary, depending on the dimensions of the bottom portion 1000.

FIG. 10 shows the body 1002 having a protruding member 1006. In one embodiment, the protruding member 1006 is formed as a continuing component of the body 1002. In another embodiment, the protruding member 1006 may be removably coupled to the body 1002 through a twist in, snap in, or other configuration. The protruding member 1006 is shaped to pierce through at least a first portion 1008 of the first packet 102a and a second portion 1010 of the second packet 106a, e.g., a puncture region, in order to release the shampoo 104 and the shampoo additive (as shown in FIG. 1), respectfully.

In one embodiment, the material of the first portion 1008 of the first packet 102a and the second portion 1010 of the second packet 106a may be foil that can easily be punctured by the protruding member 1006. In other embodiments, the material of the first portion 1008 and the second portion 1010 may be Mylar or another type of material that can easily be punctured by the protruding member 1006. In other embodiments, an entire upper layer 1012 of the first packet 102a and an entire upper layer 1014 of the second packet 106a may be the puncture region.

Though FIG. 10 shows both the first packet 102a and the second packet 106a, either or both the first packet 102a and the second packet 106a may be inserted within the bottom portion 1000 in preparation for use during bathing. Advantageously, the caretaker does not have to open the first packet 102a and/or the second packet 106a to access the inner contents. The caretaker can simply insert at least one of the first packet 102a and the second packet 106a within the bottom portion 1000. Thereafter, the bottom portion 1000 can be coupled to the body 1002 and at least one of the first packet 102a and the second packet 106a can be punctured to access the shampoo 104 and/or the shampoo additive 108. Following the bath, the bottom portion 1000 may be removed and the first packet 102a and/or the second packet 106a may be recycled or disposed of by the caretaker.

A single-use shampoo system, kit, and method for delivering concentrated dilutable hair care products has been disclosed that features a first single-use packet sized and shaped to fit within a standard-sized A4 envelope and a quantity of shampoo concentrate stored within the first single-use packet. Other features of the invention have been disclosed that provide a second single-use packet sized and shaped to fit within a standard-sized A4 envelope and a quantity of shampoo additive stored within the second single-use packet, but are not intended to be limited to the particular details disclosed herein.

What is claimed is:

1. A single-use shampoo system for delivering concentrated dilutable hair care products, the single-use shampoo system, comprising:
a first single-use packet sized and shaped to fit within a standard-sized A4 envelope; and
a quantity of shampoo concentrate stored within the first single-use packet.

2. The single-use shampoo system according to claim 1, further comprising:
a second single-use packet sized and shaped to fit within a standard-sized A4 envelope; and
a quantity of shampoo additive stored within the second single-use packet.

3. The single-use shampoo system according to claim 2, wherein:
the quantity of shampoo additive is at least one of a medication, a fragrance, and a conditioner.

4. The single-use shampoo system according to claim 1, further comprising:
a dilution container sized and shaped to receive the quantity of shampoo, the dilution container having a visual indicia corresponding to a volume fill amount.

5. The single-use shampoo system according to claim 4, wherein the dilution container further comprises:
a removably couplable bottom portion sized and shaped to receive the first single-use packet.

6. The single-use shampoo system according to claim 1, wherein the quantity of shampoo concentrate further comprises:
a dilution strength of approximately 10 parts of water to 1 part shampoo.

7. The single-use shampoo system according to claim 1, further comprising:
a display holder having a base and a support wall, the base defining an aperture sized and shaped to receive the first single-use packet.

8. The single-use shampoo system according to claim 1, wherein:
the quantity of shampoo concentrate is less than five fluid ounces.

9. A kit for providing custom dilutable hair care products for one time use, the kit comprising:
a first packet defining a volume of less than five fluid ounces;
a quantity of shampoo concentrate stored within the first packet;
a second packet defining a volume of less than five fluid ounces;
a quantity of shampoo additive stored within the second packet;
a dilution container sized and shaped to receive the quantity of shampoo concentrate and the quantity of shampoo additive; and
a compact storage case operable to transport the kit.

10. The kit according to claim 9, further comprising:
a dilution container cover removably coupled to the dilution container.

11. The kit according to claim 9, further comprising:
an elongated mixing member.

12. The kit according to claim 9, wherein:
the quantity of shampoo additive is at least one of a conditioner, a medication, and a fragrance.

13. The kit according to claim 9, wherein the dilution container further comprises:
a removably couplable bottom sized and shaped to receive at least one of the first packet and the second packet.

14. The kit according to claim 9, wherein the dilution container further comprises:
a protruding member shaped to pierce at least a portion of the first packet.

15. A method of using a single-use shampoo system for delivering concentrated dilutable hair care products, the method comprising:
providing:
a first single-use packet sized and shaped to fit within a standard-sized A4 envelope;
a quantity of shampoo concentrate stored within the first single-use packet; and
a dilution container having a removably couplable bottom portion sized and shaped to receive the first single-use packet;
transferring the quantity of shampoo concentrate from the first single-use packet to the dilution container; and
diluting the quantity of shampoo concentrate to a select dilution strength with a volume of water.

16. The method according to claim 15, further comprising:
providing a second single-use packet sized and shaped to fit within a standard-sized A4 envelope; and
a quantity of shampoo additive stored within the second single-use packet.

17. The method according to claim 16, further comprising:
adding the quantity of shampoo additive to the quantity of shampoo concentrate and the volume of water.

18. The method according to claim 15, further comprising:
inserting the first single-use packet within the bottom portion of the dilution container.

19. The method according to claim 15, further comprising:
bathing a pet with the quantity of shampoo concentrate and the volume of water.

20. The method according to claim 15, further comprising:
disposing of the first single-use packet following use.
